(19) United States
(12) Patent Application Publication
(10) Pub. No.: US 2002/0153344 A1
(43) Pub. Date: Oct. 24, 2002

(54) Convertible drink shaker and glass

(76) Inventors: Richard M. Pola, Hermosa Beach, CA (US); Lisa L. Pola, Hermosa Beach, CA (US)

Correspondence Address: Crockett &: Crockett, Suite 400, 24012 Calle De La Plata, Laguna Hills, CA, 92653, US

(21) Appl. No.: 09/838,702

(22) Filed: Apr. 18, 2001

(51) Int. Cl. B01F 11/00; B65D 51/32; B65D 51/28

(52) U.S. Cl. 215/387; 220/568; 220/4.07; 220/4.21; 220/23.86; 220/212

(57) ABSTRACT

A combination drink shaker, drinking glass and shot glass all combined into one device. The device can be formed by four elements, a shaker cup, a shaker lid, a shot glass, and a strainer, which are convertible from a drink shaker to a drinking glass.

### FIELD OF THE INVENTIONS

The invention relates generally to drink shakers and drinking glasses.

### BACKGROUND OF THE INVENTIONS

Drink shakers are well known in the art, especially for shaking martinis and margaritas. They generally include a shaker cup and a shaker lid, and maybe perhaps a strainer as well. In use, the shaker cup is filled with the ingredients for the particular drink. Depending upon the drink, ice is sometimes added. The shaker lid is placed on top of the shaker cup and the drink shaker is then shaken. The contents are then poured out of the shaker into a drinking glass and served.

Drinking glasses come in many shapes and sizes. The type of drink being served generally determines the shape and size of the glass. There are, for example, martini glasses, margarita glasses, wine glasses, ice tea glasses etc., each of them having a distinctive shape.

Shot glasses also have a particular shape and are used to measure out a shot of liquor. Serving liquor in shot glasses provides assurance to purchasers that a full measure of alcohol is provided in a mixed beverage.

All three of these things, drink shakers, drinking glasses, and shot glasses, are complete in and of themselves and are, generally, used in conjunction with one another. Shot glasses are used to measure the alcohol into the drink shakers along with various drink mixes. Drink shakers are shaken to mix the ingredients of the drinks together. Then, the finished drink is poured from the drink shaker into a drinking glass.

Many bars and restaurants make an effort to differentiate their services and products from those of their competitors. Currently, fruit and mini-umbrellas are used to decorate the glasses, and distinctively colored liquors are also being used. Some bars give away souvenir glasses and such. Other bars are serving their margaritas in a drink shaker and giving the customer a glass to pour the drink into the glass themselves. New ways of serving and presenting drinks to please and entertain customers are always being sought as a means for distinguishing a bar or restaurant from its competition.

### SUMMARY

A new device for serving drinks is described. A drink shaker, drinking glass and shot glass are all be combined into one device, a convertible drink shaker and glass. The device includes three separate pieces, a shaker cup, a shaker lid and a shot glass, although two separate pieces may be used if the shaker lid and shot glass are combined into one piece. The device also includes a strainer.

### BRIEF DESCRIPTION OF THE DRAWINGS

FIG. 1 is a side view of the device.

FIG. 2 is an exploded view from the side of the device.

FIG. 3 is an exploded view of the device with a strainer in the ridge of the shaker lid.

FIG. 4 is an exploded view of the device with a strainer in the open end of the shaker cup.

FIG. 5 is side view of the drinking glass.

### DETAILED DESCRIPTION OF THE INVENTIONS

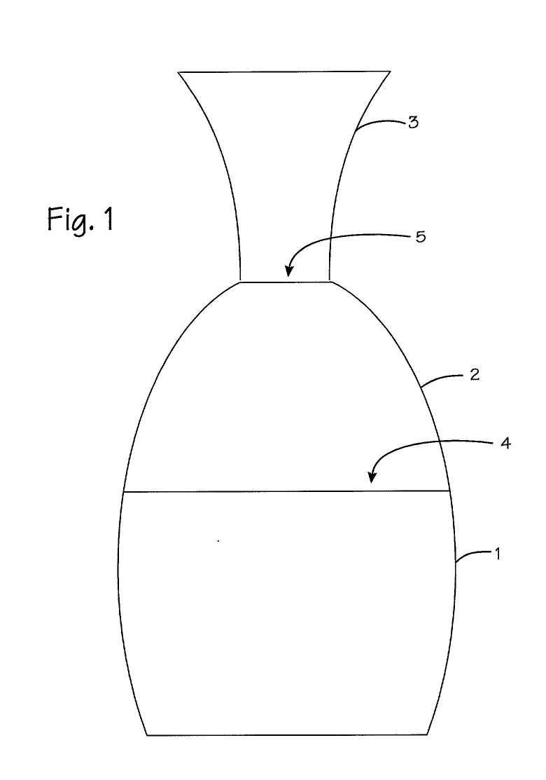

FIG. 1 illustrates the basic elements of the device, which include the shaker cup 1, the shaker lid 2, and the shot glass 3. The shaker lid is removably mounted on top of the shaker cup forming a first joint 4 and the shot glass is removably mounted on top of the shaker lid forming a second joint 5. The first and second joints are male-female joints. The elements can be composed of plastic, metal, glass, or other suitable material, and may be formed by injection molding, machining or extrusion.

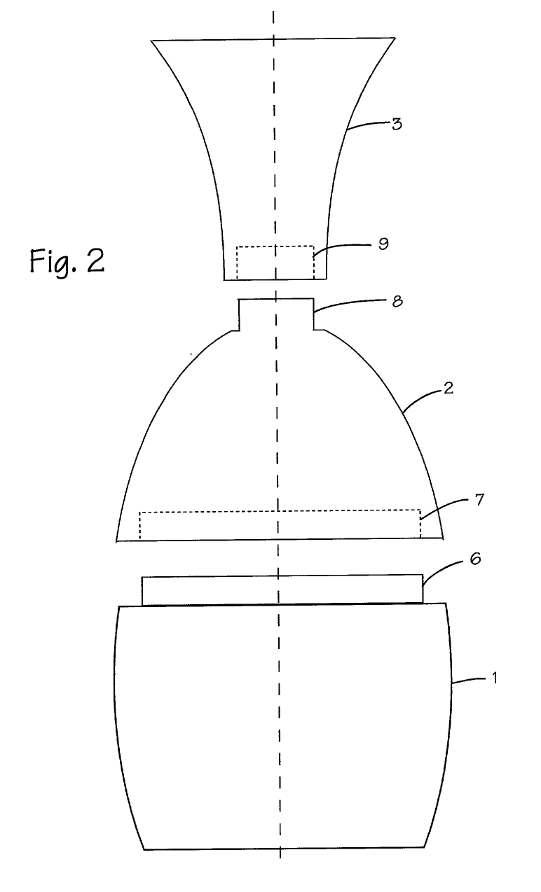

FIG. 2 show the three basic elements exploded. The first joint includes a lip 6 that is located at the open end of the shaker cup 1 and a rim 7 that is located at the second end of the shaker lid. The lip of the shaker cup forms the male portion and the rim forms the female portion, as the lip mates with the rim, the first joint is formed. The first joint forms a seal that holds the drink ingredients in the shaker as it is being shaken. A second joint is formed between the shaker lid 2 and the shot glass 3. The second end of the shaker lid includes a protruding ridge 8 that fits together with a bore 9 located at the tapered end of the shot glass. The ridge forms the male portion and the bore forms the female portion such that as they are mated together, the second joint is formed. The first and second joints are tight to the degree necessary to permit a fairly secure releasable or removable press-fit, pressure fit, or threaded connection which may be broken with the application of moderate force, without the assistance of tools.

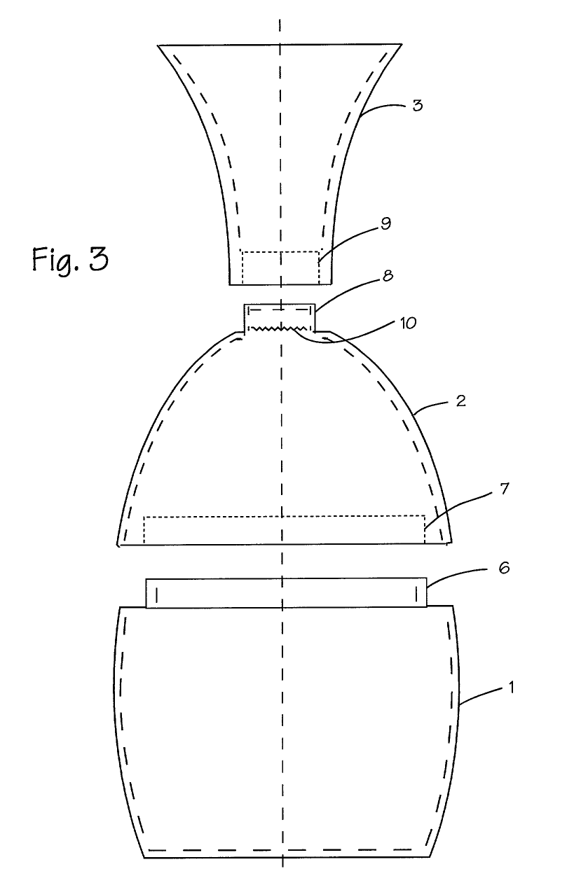

FIG. 3 illustrates the three basic elements, the shaker cup 1, the shaker lid 2 and the shot glass 3. Also included is a strainer 10 located within the ridge 8 of the shaker lid. The ridge forms a hole that is open to the interior of the shaker. The shot glass, when mated to the shaker lid, covers the ridge to keep the drink ingredients in the shaker as it is being shaken. To pour out the contents of the shaker, the shot glass is removed, exposing the hole and the strainer.

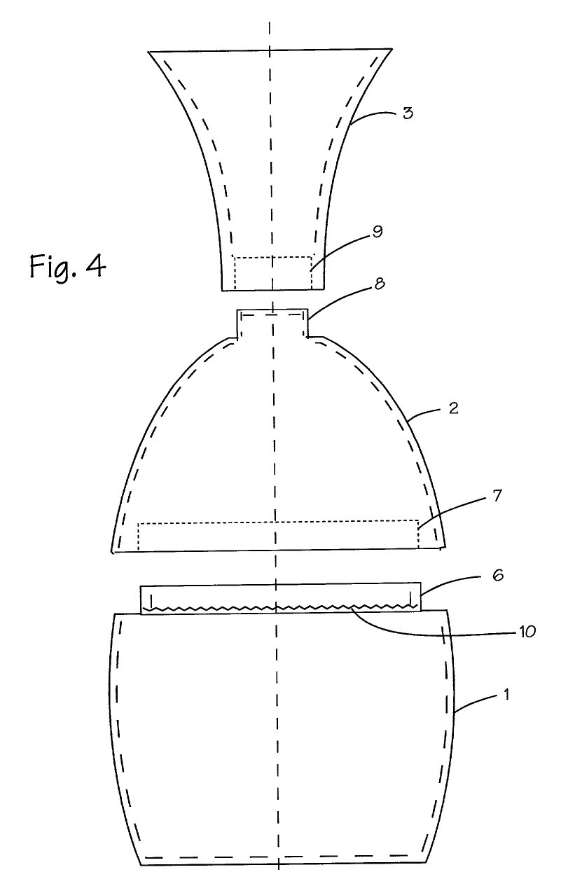

FIG. 4 illustrates the the same three basic elements, the shaker cup 1, the shaker lid 2, the shot glass 3. Also included is a strainer 10 that is located within the lip of the shaker cup. The ridge is not open to the interior of the shaker lid, thus, the shot glass does not need to be mounted onto the shaker lid in order to seal the shaker. In this embodiment the ridge mates with the tapered end of the shot glass to form the second joint which holds the shot glass on top of the shaker lid.

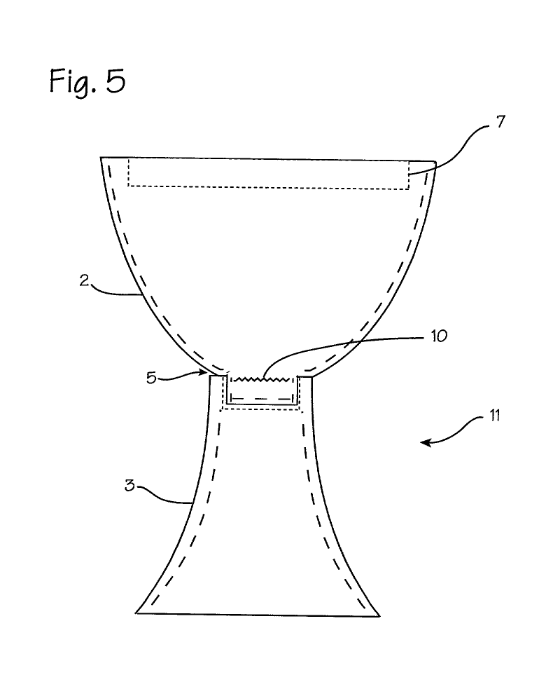

FIG. 5 illustrates the inverted shot glass 3 mated to the inverted shaker lid 2 to form the drinking glass 11. The inverted shot glass functions as the glass stem and the inverted shaker lid functions as the glass cup. The inverted shot glass is placed upon a surface such as a table with the flared end down. Having the shot glass with a flared end results in a glass stem (inverted shot glass) with increased stability for supporting the glass cup (inverted shaker lid).

In using the device illustrated in FIG. 3, the shaker cup is filled with the drink ingredients and ice, then the shaker lid is placed on top of the shaker cup. The shot glass is mounted on top of the shaker lid to seal the shaker. The shot glass is then filled with a liquor of the drinker or customer's choice. The device is served as shown in FIG. 1, with the shot glass is mounted on top of the shaker lid, and the shaker lid mounted on top of the shaker cup. The customer can either drink the liquor in the shot glass straight or pour it into the shaker. The customer can pour the liquor from the shot glass into the shaker through the hole formed by the ridge or the customer can remove the shaker lid and pour it into the shaker cup directly. The tapered end of the shot glass must be placed on top of the ridge of the shaker lid in order to cover the hole prior to shaking. Once the drink has been shaken the customer then lifts the shot glass off of the shaker lid, inverts the shot glass, and places the flared end of the shot glass on the table. Then, the shaker lid can be removed from the shaker cup, inverted, and place on top of the inverted shot glass. Thus the assembly forms a glass wherein the shot glass is the glass stem and the shaker lid is the glass cup. The contents of the shaker cup can be poured into the glass for drinking.

Similarly, in using the device illustrated in FIG. 4, the shaker cup is filled with the drink ingredients and ice, then the shaker lid is placed on top of the shaker cup to seal the shaker. The shot glass is mounted on top of the shaker lid. The shot glass is then filled with a liquor of the drinker or customer's choice. The device is served with the shot glass mounted on top of the shaker lid, and the shaker lid mounted on top of the shaker cup. The customer can either drink the liquor in the shot glass straight or remove the shaker lid and pour it into the shaker cup. The shaker lid is placed on top of the shaker cup to seal the drink ingredients into the shaker. In this embodiment the shot glass is not needed to seal the shaker, therefore the shot glass can immediately be inverted and placed on the table. Once the drink has been shaken, the customer lifts the shaker lid off of the shaker cup, inverts the shaker cup and places onto the inverted shot glass, thus forming a glass wherein the shot glass is the glass stem and the shaker lid is the glass cup. The contents of the shaker cup can be poured into the glass for drinking.

Thus, while the preferred embodiments of the device have been described in reference to the environment in which they were developed, they are merely illustrative of the principles of the inventions. Other embodiments and configurations may be devised without departing from the spirit of the inventions and the scope of the appended claims.

We claim:

1. A convertible drink shaker and glass comprising:
a shaker cup having an open end and a closed end;
a shaker lid removably mounted to the open end of the shaker cup, the shaker lid having a first end and a second end; and
a shot glass removably mounted to the second end of the shaker lid;
wherein the shot glass when inverted is a glass stem and the shaker lid when inverted is a glass cup, whereby the glass stem supports the glass cup such that a drinking glass is formed.

2. A combination drink shaker and glass comprising:
a shaker cup having an open end and a closed end;
a shaker lid removably mounted to the open of the shaker cup, the shaker lid having a first end and a second end; and
a shot glass removably mounted to the second end of the shaker lid;
wherein the shot glass and shaker lid, when inverted,form a drinking glass.
